(19) United States
(12) Patent Application Publication
(10) Pub. No.: US 2024/0382384 A1
(43) Pub. Date: Nov. 21, 2024

(54) Bottle With Time Indication Device

(71) Applicants: Manteo Soto, Salt Lake City, UT (US); Taylor Sauers, Salt Lake City, UT (US)

(72) Inventors: Manteo Soto, Salt Lake City, UT (US); Taylor Sauers, Salt Lake City, UT (US)

(21) Appl. No.: 18/199,787

(22) Filed: May 19, 2023

(51) Int. Cl. A61J 9/08

(52) U.S. Cl. CPC A61J 9/085; A61J 2205/50

(57) ABSTRACT

A bottle with time indication device for indicating a selected time includes a bottle containing a perishable liquid. A nipple is removably positioned upon the bottle and provides an access for a mouth of a user to suck the perishable liquid out from the bottle. A collar removably secures the nipple to the bottle and a time indicator is coupled to the collar and displays a selected time of day, thus the selected time of day corresponds to using the perishable liquid within the bottle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to infant bottles and more particularly pertains to a new infant bottle for indicating a selected time.

### (2) Description of Related Art Including Information Disclosed Under 37 CFR 1.97 and 1.98

The prior art relates to infant bottles and includes a variety of infant bottles including a time indicator coupled to the bottle. Known prior art does not include an infant bottle including the time indicator coupled to a collar of the infant bottle.

### BRIEF SUMMARY OF THE INVENTION

An embodiment of the disclosure meets the needs presented above by generally comprising a bottle configured for containing a perishable liquid. A nipple is removably positioned upon the bottle and is configured for providing an access for a mouth of a user to suck the perishable liquid out from the bottle. A collar removably secures the nipple to the bottle and a time indicator is coupled to the collar and displays a selected time of day, wherein the selected time of day corresponds to using the perishable liquid within the bottle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric in-use view of a bottle with time indication device according to an embodiment of the disclosure.

FIG. 2 is a front view of an embodiment of the disclosure.

FIG. 3 is a cross-sectional view of an embodiment of the disclosure taken along Line 3-3 of FIG. 2.

FIG. 4 is a top view of an embodiment of the disclosure.

FIG. 5 is a front view of an alternative embodiment of the disclosure.

FIG. 6 is a cross-sectional view of an alternative embodiment of the disclosure taken along Line 6-6 of FIG. 5.

FIG. 7 is a top view of an alternative embodiment of the disclosure.

FIG. 8 is a cross-sectional view of an embodiment of the disclosure taken along Line 8-8 of FIG. 2.

### DETAILED DESCRIPTION OF THE INVENTION

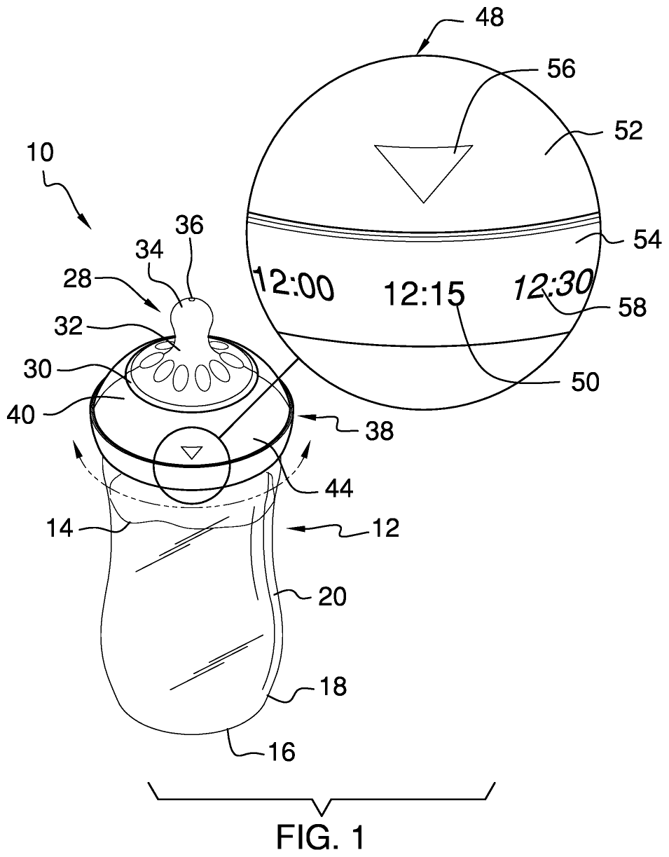

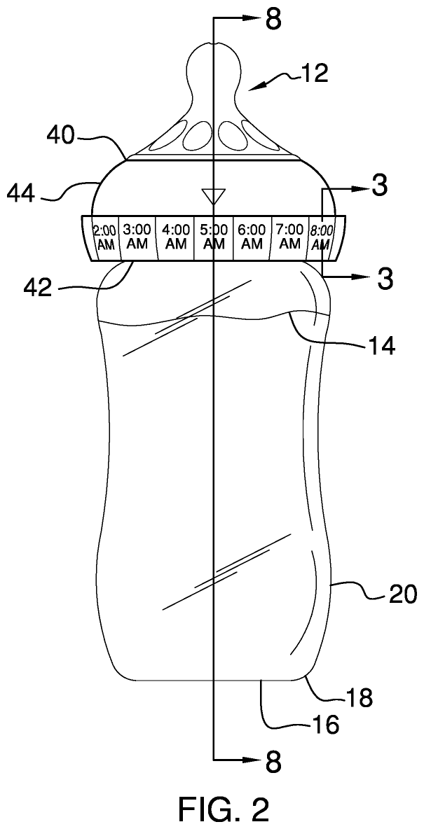

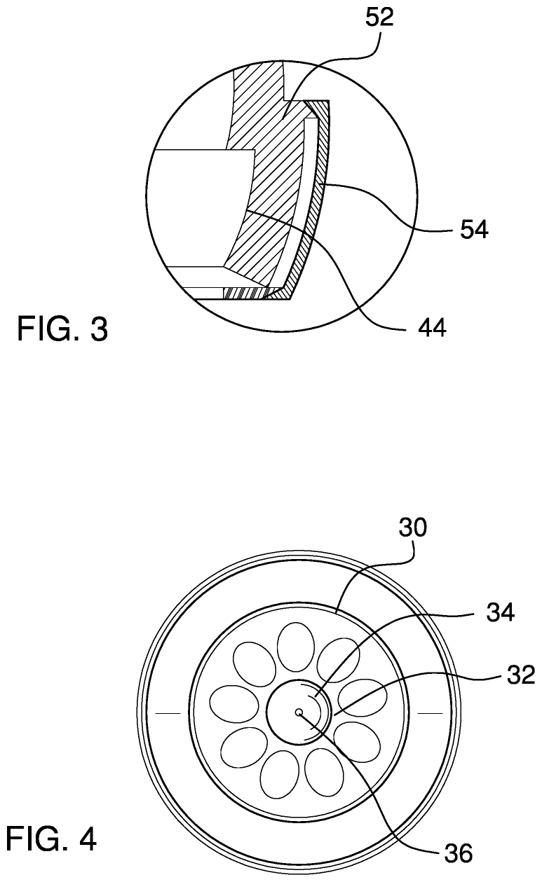

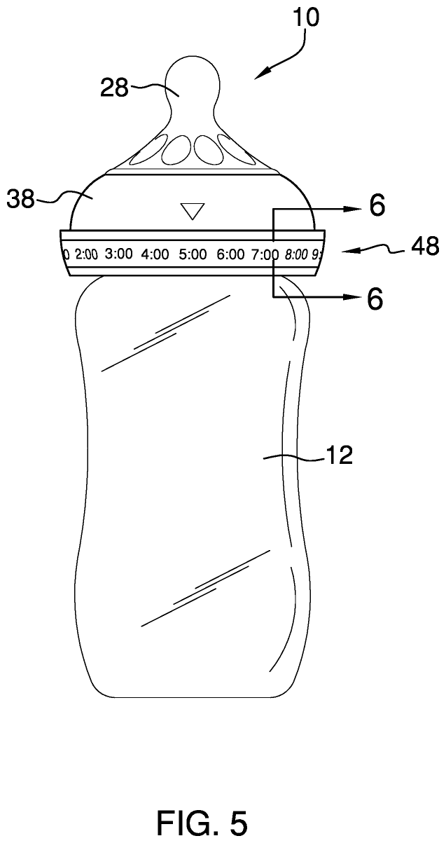

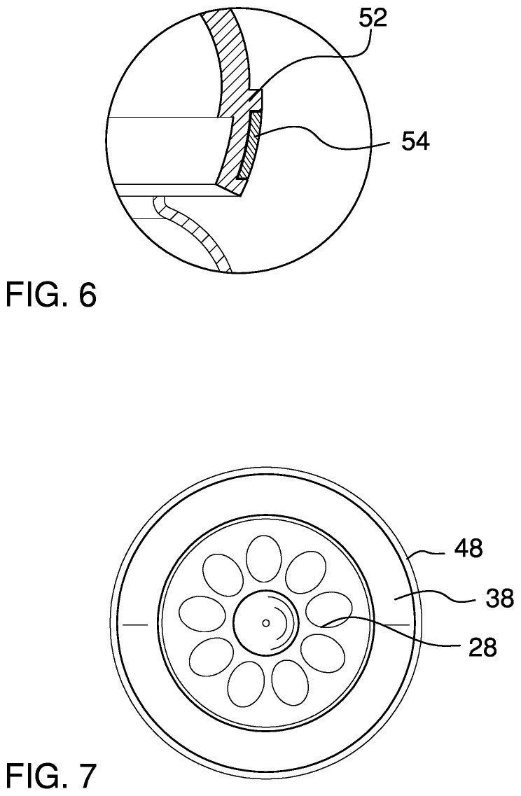

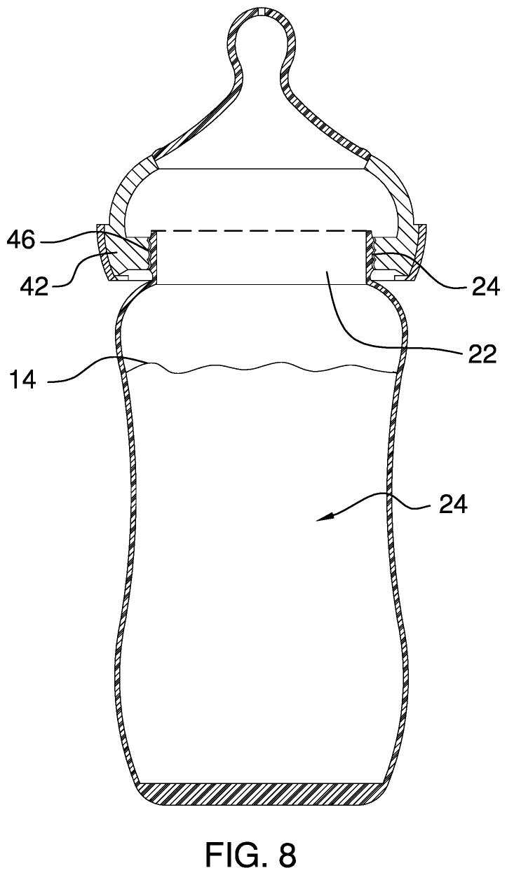

With reference now to the drawings, and in particular to FIGS. 1 through 8 thereof, a new infant bottle embodying the principles and concepts of an embodiment of the disclosure and generally designated by the reference numeral 10 will be described.

As best illustrated in FIGS. 1 through 8, the bottle with time indication device 10 generally comprises a bottle 12 configured for containing a perishable liquid 14 such as breast milk or another conventional milk used to feed infants. The bottle 12 includes a bottom wall 16 having a perimeter edge 18 and a perimeter wall 20 couples to the perimeter edge 18 and protrudes upward from the bottom wall 16. An upper edge of the perimeter wall 20 defines an opening 22 into an interior space 24 of the bottle 12. The opening 22 will typically have an exterior threading 26

A nipple 28 is removably positioned upon the bottle 12 and is configured for providing an access for a mouth of a user to suck the perishable liquid 14 out from the bottle 12. The nipple 28 has a base ring 30 and an outer wall 32 couples to the base ring 30 and tapers upward from the base ring 30 to a tip 34. The tip 34 is normally a bulb and has an aperture 36 extending therethrough.

A collar 38 removably secures the nipple 28 to the bottle 12. The collar 38 normally comprises a continuous loop having a top end 40, a bottom end 42, and a perimeter surface 44. The top end 40 couples to the base ring 30 of the nipple 28 and the bottom end 42 removably secures to the opening 22 of the bottle 12. The bottom end 42 will normally have an interior threading 46, wherein the interior threading 46 of the bottom end 42 removably engages by threading to the exterior threading 26 of the opening 22 of the bottle 12.

A time indicator 48 is coupled to the collar 38 and displays a selected time of day 50, wherein the selected time of day 50 corresponds to when to use the perishable liquid 14 within the bottle 12. For example, the selected time of day 50 can either represent when the bottle 12 was filled with the perishable liquid 14, or the selected time of day 50 can represent when the perishable liquid 14 within the bottle expires. The time indicator 48 includes a first portion 52 and a second portion 54. The first portion 52 mounts to the perimeter surface 44 of the collar 38 and the second portion 54 is rotatably attached to the first portion 52, wherein the second portion 54 rotates about the first portion 52. The first portion 52 normally has a first indicia 56 displaying an indicator and may comprise an arrow pointing towards the second portion 54. The second portion 54 has a second indicia 58 displaying hours of the day including a plurality of variable markings representing fifteen minutes between each other.

In use, the interior space 24 of the bottle 12 receives the perishable liquid 14 through the opening 22. The collar 38 then secures by threading to the opening 22 of the bottle 12. The time indicator 48 is then set to a selected time of day 50 for the user to be able to determine when to use the perishable liquid 14 before it becomes spoiled.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A liquid container with time indication device comprising:
a bottle configured for containing a perishable liquid;
a nipple being removably positioned upon said bottle and being configured for providing an access for a mouth of a user to suck the perishable liquid out from said bottle;
a collar removably securing said nipple to said bottle; and
a time indicator being coupled to said collar and displaying a selected time of day, wherein said selected time of day corresponds to using the perishable liquid within said bottle.

2. The liquid container with time indication device of claim 1, wherein said bottle includes a bottom wall having a perimeter edge, a perimeter wall coupling to said perimeter edge and protruding upward from said bottom wall, an upper edge of said perimeter wall defining an opening into an interior space of said bottle.

3. The liquid container with time indication device of claim 2, wherein said opening has an exterior threading.

4. The liquid container with time indication device of claim 3, wherein said nipple having a base ring, an outer wall coupling to said base ring and tapering upward from said base ring to a tip, said tip being a bulb and having an aperture extending therethrough.

5. The liquid container with time indication device of claim 4, wherein said collar comprises a continuous loop having a top end, a bottom end, and a perimeter surface, said top end coupling to said base ring of said nipple, said bottom end removably securing to said opening of said bottle.

6. The liquid container with time indication device of claim 5, wherein said bottom end has an interior threading, wherein said interior threading of said bottom end removably engages by threading to said exterior threading of said opening of said bottle.

7. The liquid container with time indication device of claim 5, wherein said time indicator includes a first portion and a second portion, said first portion mounting to said perimeter surface of said collar, said second portion being rotatably attached to said first portion, wherein said second portion rotates about said first portion.

8. The liquid container with time indication device of claim 7, wherein said first portion has a first indicia displaying an indicator, said indicator comprising an arrow pointing towards said second portion, said second portion having a second indicia displaying hours of the day including a plurality of variable markings representing fifteen minutes between each other.

9. A liquid container with time indication device comprising:
a bottle configured for containing a perishable liquid, said bottle including a bottom wall having a perimeter edge, a perimeter wall coupling to said perimeter edge and protruding upward from said bottom wall, an upper edge of said perimeter wall defining an opening into an interior space of said bottle, said opening having an exterior threading;
a nipple being removably positioned upon said bottle and being configured for providing an access for a mouth of a user to suck the perishable liquid out from said bottle, said nipple having a base ring, an outer wall coupling to said base ring and tapering upward from said base ring to a tip, said tip being a bulb and having an aperture extending therethrough;
a collar removably securing said nipple to said bottle, said collar comprising a continuous loop having a top end, a bottom end, and a perimeter surface, said top end coupling to said base ring of said nipple, said bottom end removably securing to said opening of said bottle, said bottom end having an interior threading, wherein said interior threading of said bottom end removably engages by threading to said exterior threading of said opening of said bottle; and
a time indicator being coupled to said collar and displaying a selected time of day, wherein said selected time of day corresponds to using the perishable liquid within said bottle, said time indicator including a first portion and a second portion, said first portion mounting to said perimeter surface of said collar, said second portion being rotatably attached to said first portion, wherein said second portion rotates about said first portion, said first portion having a first indicia displaying an indicator, said indicator comprising an arrow pointing towards said second portion, said second portion having a second indicia displaying hours of the day including a plurality of variable markings representing fifteen minutes between each other.
